(19) United States
(12) Patent Application Publication
(10) Pub. No.: US 2025/0190978 A1
(43) Pub. Date: Jun. 12, 2025

(54) SYSTEMS AND METHODS FOR BLOCKCHAIN IDENTITY PROOFING VIA FEDERATION PROTOCOLS FROM TRUSTED PARTIES

(71) Applicant: JPMORGAN CHASE BANK, N.A., New York, NY (US)

(72) Inventors: Neill CLAYTON-SMITH, Claymont, DE (US); Gerardo GEAN, Plano, TX (US); Tyrone D. LOBBAN, Loughton (GB); George KASSIS, London (GB); Dipti AHUJA, Basking Ridge, NJ (US)

(21) Appl. No.: 18/534,008

(22) Filed: Dec. 8, 2023

(51) Int. Cl. G06Q 20/36; G06Q 20/32; G06Q 20/40

(52) U.S. Cl. CPC G06Q 20/3674; G06Q 20/3221; G06Q 20/326; G06Q 20/4014

(57) ABSTRACT

Blockchain identity proofing via federation protocols is disclosed. A method may include: receiving, at a digital wallet application for a financial institution on a customer electronic device, a customer login from a customer; receiving, by the digital wallet application and from the customer, a request for an assertion, wherein the request redirects a session with the digital wallet application to a financial institution backend via a financial institution website or a financial institution application using a federation protocol; authenticating, by the financial institution backend, the customer; confirming, by the financial institution backend, the assertion using verified customer information in a verified customer information database; redirecting, by the financial institution backend, the session to the digital wallet application; returning, by the financial institution backend and using the federation protocol, the assertion to the digital wallet application; and writing, by the digital wallet application, the assertion to a distributed ledger.

### BACKGROUND OF THE INVENTION

### 1. Field of the Invention

Embodiments generally relate to systems and methods for blockchain identity proofing via federation protocols from trusted parties.

### 2. Description of the Related Art

The blockchain environment allows an individual to create an identity usable in that environment. For various cases, blockchain identity needs to be tied back to a verifiable individual.

### SUMMARY OF THE INVENTION

Systems and methods for blockchain identity proofing via federation protocols from trusted parties are disclosed. In one embodiment, a method may include: (1) receiving, at a digital wallet application for a financial institution on a customer electronic device, a customer login from a customer; (2) receiving, by the digital wallet application and from the customer, a request for an assertion, wherein the request redirects a session with the digital wallet application to a financial institution backend via a financial institution website or a financial institution application using a federation protocol; (3) authenticating, by the financial institution backend, the customer; (4) confirming, by the financial institution backend, the assertion using verified customer information in a verified customer information database; (5) redirecting, by the financial institution backend, the session to the digital wallet application; (6) returning, by the financial institution backend and using the federation protocol, the assertion to the digital wallet application; and (7) writing, by the digital wallet application, the assertion to a distributed ledger.

In one embodiment, the method may also include sending, by the digital wallet application, a pointer to the assertion on the distributed ledger to a relying party.

In one embodiment, the assertion may be based on the verified customer information.

In one embodiment, the assertion may be based on an account that the customer has with the financial institution.

In one embodiment, the assertion may be returned in an application programming interface call.

In one embodiment, the assertion may be returned in a token.

According to another embodiment, a system may include: a customer electronic device for a customer executing a digital wallet application; a financial institution backend for a financial institution executing an identity management computer program; a verified customer information database comprising verified customer information for the customer; and a distributed ledger. The digital wallet application may be configured to receive a customer login from a customer; the digital wallet application may be configured to receive a request for an assertion from the customer; the digital wallet application may be configured to redirect a session with the digital wallet application to the financial institution backend via a financial institution website or a financial institution application using a federation protocol; the financial institution backend may be configured to authenticate the customer; the financial institution backend may be configured to confirm the assertion using the verified customer information in the verified customer information database; the financial institution backend may be configured to redirect the session to the digital wallet application; the financial institution backend may be configured to return the assertion to the digital wallet application using the federation protocol; and the digital wallet application may be configured to write the assertion to the distributed ledger.

In one embodiment, the digital wallet application may be configured to send a pointer to the assertion on the distributed ledger to a relying party.

In one embodiment, the assertion may be based on the verified customer information.

In one embodiment, the assertion may be based on an account that the customer has with the financial institution.

In one embodiment, the assertion may be returned in an application programming interface call.

In one embodiment, the assertion may be returned in a token.

According to another embodiment, a non-transitory computer readable storage medium, may include instructions stored thereon, which when read and executed by one or more computer processors, cause the one or more computer processors to perform steps comprising: receiving a customer login from a customer; receiving a request for an assertion from the customer; redirecting a session to a financial institution backend for a financial institution via a financial institution website or a financial institution application using a federation protocol; receiving a redirect of the session from the financial institution backend; receive the assertion based on verified customer information from the financial institution backend using the federation protocol; and writing the assertion to a distributed ledger.

In one embodiment, the non-transitory computer readable storage medium may also include instructions stored thereon, which when read and executed by one or more computer processors, cause the one or more computer processors to perform steps comprising: sending a pointer to the assertion on the distributed ledger to a relying party.

In one embodiment, the assertion may be based on the verified customer information.

In one embodiment, the assertion may be based on an account that the customer has with the financial institution.

In one embodiment, the assertion may be returned in an application programming interface call.

In one embodiment, the assertion may be returned in a token.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for blockchain identity proofing via federation protocols from trusted parties according to an embodiment;

FIG. 2 illustrates a method for blockchain identity proofing via federation protocols from trusted parties according to an embodiment;

FIG. 3 depicts an exemplary computing system for implementing aspects of the present disclosure.

### DETAILED DESCRIPTION OF PREFERRED EMBODIMENTS

Embodiments are directed to systems and methods for blockchain identity proofing via federation protocols from trusted parties.

Certain businesses, such as financial institutions, are in a unique position to vouch for their customers' identities since financial institutions are required to comply with “Know Your Customer” standards. Embodiments leverage this and the use of one or more federation protocols, such as the OpenId standard, whereby a customer may consent to the financial institution sharing an assertion of the customers identity to a blockchain vault. The assertion may include various attributes that the financial institution holds, such as the customer's name, address, date of birth, social security number, credit score, etc. The customer may then share a certification from the financial institution for any of these attributes with parties that need to seek to rely on this information.

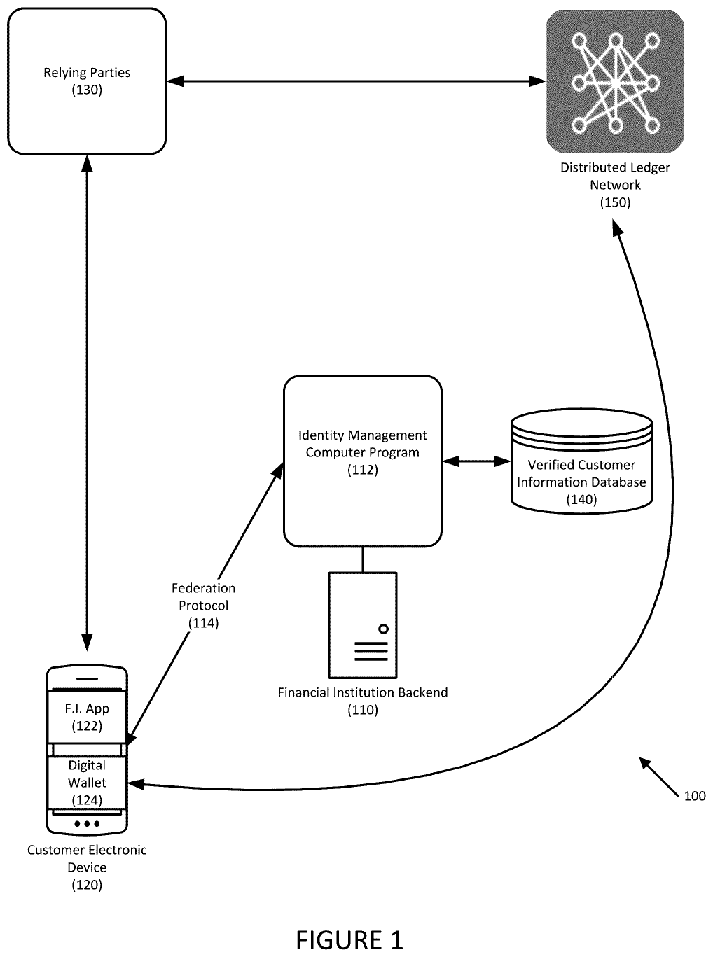

Referring to FIG. 1, a system for blockchain identity proofing via federation protocols from trusted parties is disclosed according to an embodiment. System 100 may include financial institution backend 110, which may be a server (e.g., physical and/or cloud-based server), a computer (e.g., workstation, desktop, notebook, laptop, etc.), an Internet of Things (“IoT”) appliance, etc. Financial institution backend 110 may execute identity management computer program 112, which may communicate with financial institution application (“F.I. App”) 122 and/or user digital wallet application 124 on customer electronic device 120. Financial institution application 122 may be a stand-alone app or it may be provided in a browser window.

Customer electronic device 120 may be, for example, a computer (e.g., workstation, desktop, notebook, laptop, tablet, etc.), a smart device (e.g., smartphone, smart watch, etc.), an Internet of Things (“IoT”) appliance, etc.

Using digital wallet application 124, a customer may indicate that the customer wants to receive assertions from an identity provider, such as a financial institution. Digital wallet application 124 may communicate with identity management computer program 112 using federation protocol 114 and may request one or more assertions about the customer. For example, the assertions may relate to any information that the financial institution may maintain about the customer, such as date of birth, age, contact information, account balances, available credit, credit score, credit worthiness, duration as customer, income, etc.

The request may result in financial institution application 122 or a browser being launched. The customer may authenticate to identity management computer program 112 via financial institution app 122 using the customer's banking credentials (e.g., username and password, biometrics, etc.), out of band communication (e.g., a one-time passcode), combinations thereof, etc.

After authentication, via financial institution application 122 or the browser, the customer may be asked to consent to sharing information with digital wallet application 124. This may be auto-consented to as part of the request process. Control may be returned to digital wallet application 124 following the flows for federation protocol 114. Identity management computer program 112 may return assertions about the customer to digital wallet application 124 in a form that is specific to the type of federation protocol 114 being used. Digital wallet application 124 may then provision the assertions from the financial institution in distributed ledger network 150.

The manner in which the assertions are returned may depend on the federation protocol 114 that is used; for example, using the OAuth federation protocol, the assertions may be returned by digital wallet application 124 making a subsequent API call for a signed payload. For the OpenID Connect (OIDC) federation protocol, the assertions may be returned in an OIDC IDToken. For the SAML federation protocol, the assertions may be returned through SAML attributes or via a subsequent API call for a signed payload.

Identity management computer program 112 may interface with verified customer information database 140. Verified customer information database 140 may maintain verified information for customers of the financial institution that have undergone Know Your Customer or similar verification.

Distributed ledger network 150 may be any suitable blockchain-based network.

Relying party 130 may be any party that seeks to rely on the assertion from the financial institution. Relying party 130 may receive an assertion from customer digital wallet application 124 or distributed ledger 150.

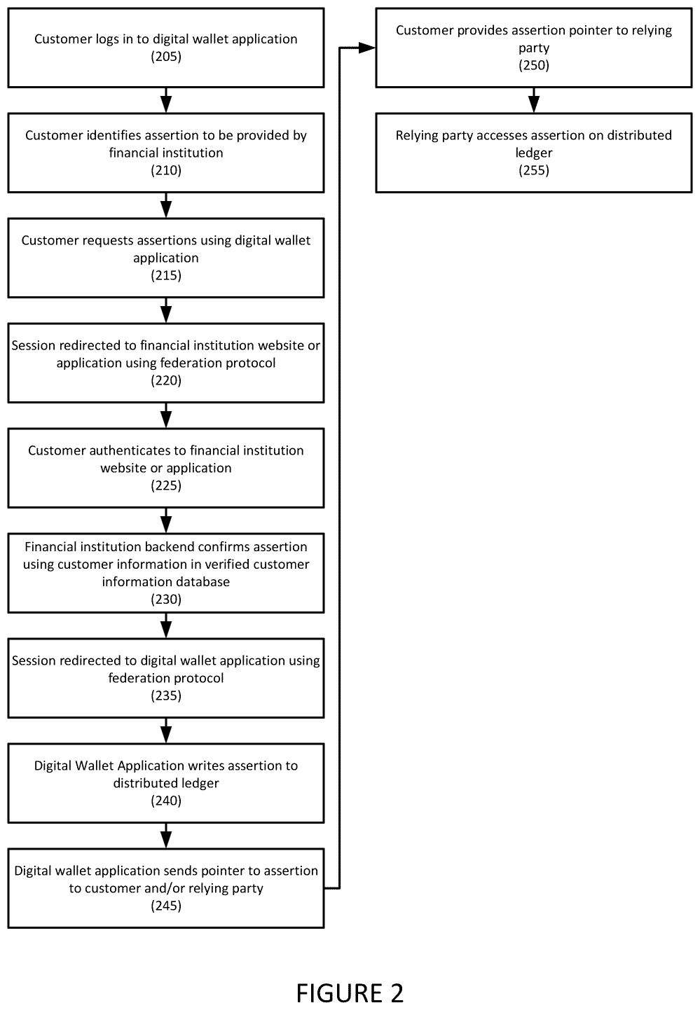

Referring to FIG. 2, a method for blockchain identity proofing via federation protocols from trusted parties is disclosed according to an embodiment.

In step 205, a customer may log in to a digital wallet application on the customer's electronic device. For example, the digital wallet application may be bound to the device. The user may log in by providing authentication credentials, such as a username and password, a biometric, out of band authentication, etc.

In step 210, the customer may identify the assertion(s) to be provided by the financial institution for a relying party. In one embodiment, the type of elements/assertion may be determined by the wallet application when the digital wallet application initiates a request to the federation provider, or they may be selected by the customer from a set on the consent screen.

In step 215, the customer may request the assertion(s) from the financial institution using the digital wallet application.

In step 220, this may redirect the session to the financial institution's website or application.

The communications may use communication standards defined by a federation protocol (e.g., OpenID, SAML, etc.) that are in place.

In step 225, the customer may authenticate to the financial institution's website or a financial institution application on the customer electronic device. For example, the customer may be authenticated by providing a username and password, biometric authentication, out-of-band authentication, etc.

In step 230, the financial institution backend may receive, from the financial institution's website or application, the request and may confirm the assertion using customer information in a verified customer information database.

This may include, for example, customer information that the financial institution has verified as part of its Know Your Customer or similar processes.

In step 235, the customer may optionally be asked to consent to sharing information with the digital wallet application. The session may then be returned to the wallet application following the federation protocol, and the assertion may be provided to the digital wallet application. In one embodiment, the assertion may be returned as part of the redirect to the wallet (e.g., OIDC/SAML).

In another embodiment, the assertion may be returned in a payload returned as a result of a subsequent API call that then returns the payload (e.g., OAuth/OIDC/SAML). In still another embodiment, the assertion may be returned in a token. In still another embodiment, the assertion may be returned as an attribute.

In step 240, the digital wallet application may write the assertion to the distributed ledger, and in step 245, may send a pointer to the assertion to a relying party or the customer.

In step 250, if not already provided, customer may provide the pointer to the assertion to a relying party.

In step 255, the relying party may access the assertion on the distributed ledger.

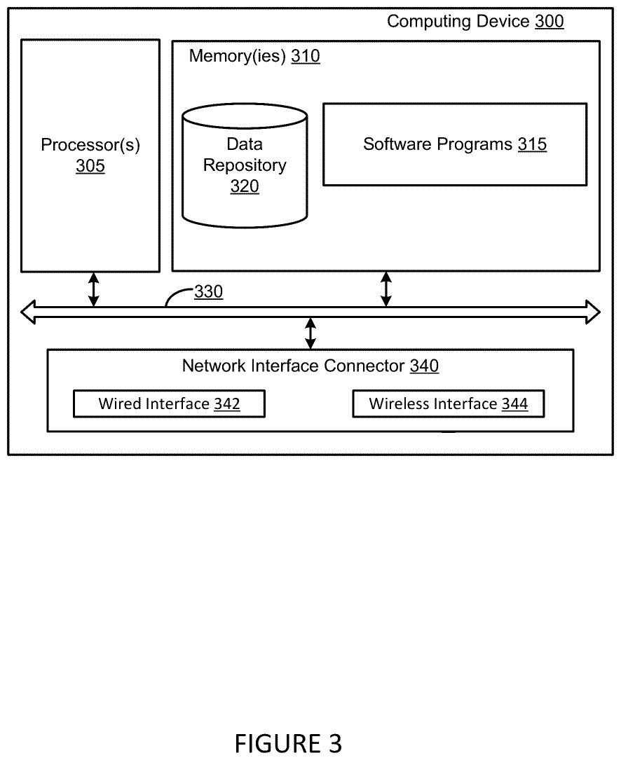

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, at a digital wallet application for a financial institution on a customer electronic device, a customer login from a customer;
receiving, by the digital wallet application and from the customer, a request for an assertion, wherein the request redirects a session with the digital wallet application to a financial institution backend via a financial institution website or a financial institution application using a federation protocol;
authenticating, by the financial institution backend, the customer;
confirming, by the financial institution backend, the assertion using verified customer information in a verified customer information database;
redirecting, by the financial institution backend, the session to the digital wallet application;
returning, by the financial institution backend and using the federation protocol, the assertion to the digital wallet application; and
writing, by the digital wallet application, the assertion to a distributed ledger.

2. The method of claim 1, further comprising:
sending, by the digital wallet application, a pointer to the assertion on the distributed ledger to a relying party.

3. The method of claim 1, wherein the assertion is based on the verified customer information.

4. The method of claim 1, wherein the assertion is based on an account that the customer has with the financial institution.

5. The method of claim 1, wherein the assertion is returned in an application programming interface call.

6. The method of claim 1, wherein the assertion is returned in a token.

7. A system, comprising:
a customer electronic device for a customer executing a digital wallet application;
a financial institution backend for a financial institution executing an identity management computer program;
a verified customer information database comprising verified customer information for the customer; and
a distributed ledger;
wherein:
the digital wallet application is configured to receive a customer login from a customer;
the digital wallet application is configured to receive a request for an assertion from the customer;
the digital wallet application is configured to redirect a session with the digital wallet application to the financial institution backend via a financial institution website or a financial institution application using a federation protocol;
the financial institution backend is configured to authenticate the customer;
the financial institution backend is configured to confirm the assertion using the verified customer information in the verified customer information database;
the financial institution backend is configured to redirect the session to the digital wallet application;
the financial institution backend is configured to return the assertion to the digital wallet application using the federation protocol; and
the digital wallet application is configured to write the assertion to the distributed ledger.

8. The system of claim 7, wherein the digital wallet application is configured to send a pointer to the assertion on the distributed ledger to a relying party.

9. The system of claim 7, wherein the assertion is based on the verified customer information.

10. The system of claim 7, wherein the assertion is based on an account that the customer has with the financial institution.

11. The system of claim 7, wherein the assertion is returned in an application programming interface call.

12. The system of claim 7, wherein the assertion is returned in a token.

13. A non-transitory computer readable storage medium, including instructions stored thereon, which when read and executed by one or more computer processors, cause the one or more computer processors to perform steps comprising:
receiving a customer login from a customer;
receiving a request for an assertion from the customer;
redirecting a session to a financial institution backend for a financial institution via a financial institution website or a financial institution application using a federation protocol;
receiving a redirect of the session from the financial institution backend;
receive the assertion based on verified customer information from the financial institution backend using the federation protocol; and
writing the assertion to a distributed ledger.

14. The non-transitory computer readable storage medium of claim 13, further including instructions stored thereon, which when read and executed by one or more computer processors, cause the one or more computer processors to perform steps comprising:
sending a pointer to the assertion on the distributed ledger to a relying party.

15. The non-transitory computer readable storage medium of claim 13, wherein the assertion is based on the verified customer information.

16. The non-transitory computer readable storage medium of claim 13, wherein the assertion is based on an account that the customer has with the financial institution.

17. The non-transitory computer readable storage medium of claim 13, wherein the assertion is returned in an application programming interface call.

18. The non-transitory computer readable storage medium of claim 13, wherein the assertion is returned in a token.
